(19) United States
(12) Patent Application Publication
(10) Pub. No.: US 2021/0287163 A1
(43) Pub. Date: Sep. 16, 2021

(54) METHOD TO PERFORM EDGE ANALYTICS USING COGNITIVE MOBILE APPLICATION IN LIMITED/NO CONNECTIVITY SCENARIOS

(71) Applicant: Carrier Corporation, Palm Beach Gardens, FL (US)

(72) Inventors: Ananthakrishnan N, Hyderabad, Telangana (IN); Paul Stoddard, Chittenango, NY (US)

(21) Appl. No.: 15/734,223

(22) PCT Filed: Dec. 5, 2019
(86) PCT No.: PCT/US2019/064571

§ 371 Date: Dec. 1, 2020

(30) Foreign Application Priority Data
Dec. 6, 2018 (IN) 201811046106

(51) Int. Cl. G06Q 10/08; G08B 21/18; H04W 4/80; H04W 4/70; H04W 4/38; H04W 4/35

(52) U.S. Cl. CPC G06Q 10/0832; G06Q 10/0831; G08B 21/18; H04W 4/35; H04W 4/70; H04W 4/38; H04W 4/80

(57) ABSTRACT

A method of monitoring operation of a transport container system on a transport ship is provided. The method including: receiving an analytics module when located at an origin dock; receiving operational data from the transport container system; analysing the operational data during a sea portion located between the origin dock and a destination dock; determining at least one of an anomaly, a potential threat, and an alert in response to the operational data; and transmitting at least one of the operational data, the anomalies, the potential threats, and the alerts to a land transceiver when the located at the destination dock.

### CROSS REFERENCE TO RELATED APPLICATIONS

This application claims the benefit of IN Application No. 201811046106, filed on 6 Dec. 2018, which is incorporated herein by reference in its entirety.

### BACKGROUND

The subject matter disclosed herein generally relates to the field of refrigerated storage containers, and more particularly to an apparatus and method for analyzing performance of the refrigerated storage containers.

A refrigerated storage container or reefer is an intermodal container (i.e., a shipping container) that is used in intermodal freight transport and may be refrigerated for the transportation of temperature sensitive cargo. An intermodal container is a large standardized shipping container, designed and built for intermodal freight transport, meaning these containers can be used across different modes of transport—from ship to rail to truck—without unloading and reloading their cargo. Intermodal containers are primarily used to store and transport materials and products efficiently and securely in the global containerized intermodal freight transport system, but smaller numbers are in regional use as well.

Other than the standard, general purpose containers, many variations of intermodal containers exist for use with different types of cargoes. The most prominent of these are refrigerated containers, such as containers with integrated refrigeration units (a.k.a. reefers) that are used in the transport of temperature sensitive goods.

### BRIEF SUMMARY

According to one embodiment, a method of monitoring operation of a transport container system on a transport ship is provided. The method including: receiving an analytics module when located at an origin dock; receiving operational data from the transport container system; analysing the operational data during a sea portion located between the origin dock and a destination dock; determining at least one of an anomaly, a potential threat, and an alert in response to the operational data; and transmitting at least one of the operational data, the anomalies, the potential threats, and the alerts to a land transceiver when the located at the destination dock.

In addition to one or more of the features described above, or as an alternative, further embodiments may include: activating an alarm in response to the alert.

In addition to one or more of the features described above, or as an alternative, further embodiments may include that the operational data is received from the transport container system through local wireless communication.

In addition to one or more of the features described above, or as an alternative, further embodiments may include that the local wireless communication includes at least one of Wi-Fi, Cellular, Bluetooth, LoRa, and Sigfox.

In addition to one or more of the features described above, or as an alternative, further embodiments may include: transmitting at least one of the operational data, the anomalies, the potential threats, and the alerts to a ship computing device of a transport ship during the sea portion.

In addition to one or more of the features described above, or as an alternative, further embodiments may include that the land transceiver is configured to transmit the at least one of the operational data, the anomalies, the potential threats, and the alerts to a computing network.

According to another embodiment, an analytics system for monitoring operation of a transport container system on a transport ship is provided. The analytics system including: a sensor configured to monitor operational data of a transport container system; a container controller configured to collect operational data from the sensor; a mobile computing device in wireless electronic communication with the container controller through local wireless communication. The mobile computing device including: a processor; and a memory including computer-executable instructions that, when executed by the processor, cause the processor to perform operations. The operations including: receiving an analytics module when located at an origin dock; receiving operational data from the transport container system; analyzing the operational data during a sea portion located between the origin dock and a destination dock; determining at least one of an anomaly, a potential threat, and an alert in response to the operational data; and transmitting at least one of the operational data, the anomalies, the potential threats, and the alerts to a land transceiver when the located at the destination dock.

In addition to one or more of the features described above, or as an alternative, further embodiments may include that the operations further include: activating an alarm in response to the alert.

In addition to one or more of the features described above, or as an alternative, further embodiments may include that the operational data is received from the transport container system through local wireless communication.

In addition to one or more of the features described above, or as an alternative, further embodiments may include that the local wireless communication includes at least one of Wi-Fi, Cellular, Bluetooth, LoRa, and Sigfox.

In addition to one or more of the features described above, or as an alternative, further embodiments may include that the operations further include: transmitting at least one of the operational data, the anomalies, the potential threats, and the alerts to a ship computing device of a transport ship during the sea portion.

In addition to one or more of the features described above, or as an alternative, further embodiments may include that the land transceiver is configured to transmit the at least one of the operational data, the anomalies, the potential threats, and the alerts to a computing network.

According computer program product tangibly embodied on a computer readable medium is provided. The computer program product including instructions that, when executed by a processor, cause the processor to perform operations including: receiving an analytics module when located at an origin dock; receiving operational data from the transport container system; analyzing the operational data during a sea portion located between the origin dock and a destination dock; determining at least one of an anomaly, a potential threat, and an alert in response to the operational data; and transmitting at least one of the operational data, the anomalies, the potential threats, and the alerts to a land transceiver when the located at the destination dock.

In addition to one or more of the features described above, or as an alternative, further embodiments may include that the operations further include: activating an alarm in response to the alert.

In addition to one or more of the features described above, or as an alternative, further embodiments may include that the operational data is received from the transport container system through local wireless communication.

In addition to one or more of the features described above, or as an alternative, further embodiments may include that the local wireless communication includes at least one of Wi-Fi, Cellular, Bluetooth, LoRa, and Sigfox.

In addition to one or more of the features described above, or as an alternative, further embodiments may include that the operations further include: transmitting at least one of the operational data, the anomalies, the potential threats, and the alerts to a ship computing device of a transport ship during the sea portion.

In addition to one or more of the features described above, or as an alternative, further embodiments may include that the land transceiver is configured to transmit the at least one of the operational data, the anomalies, the potential threats, and the alerts to a computing network.

Technical effects of embodiments of the present disclosure include performing analytics of a transport container system on a transport ship offline.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

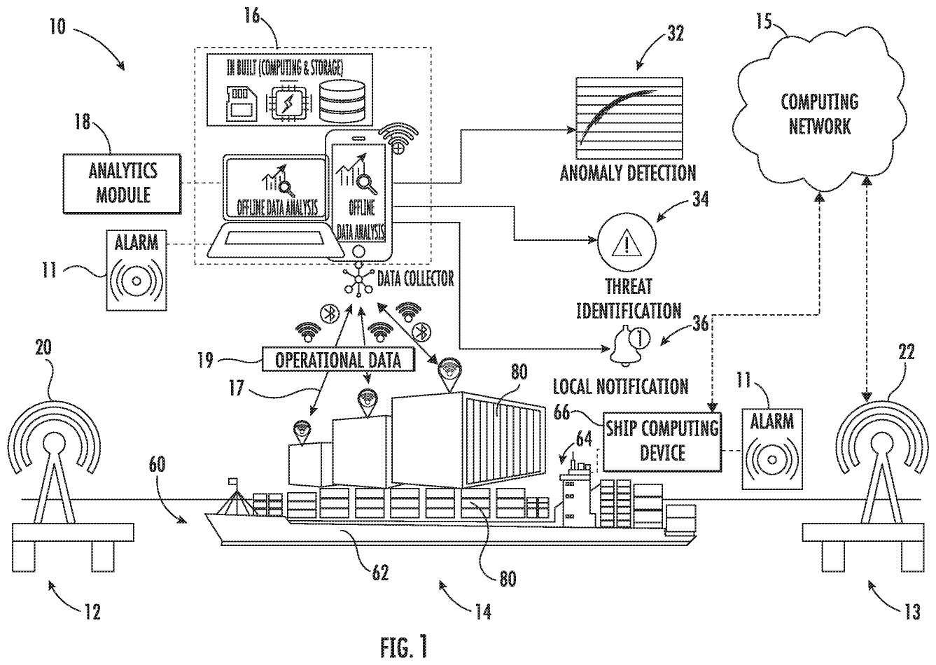

FIG. 1 illustrates a general schematic system diagram of an analytics system of a transport container system on a transport ship, in accordance with an embodiment of the disclosure;

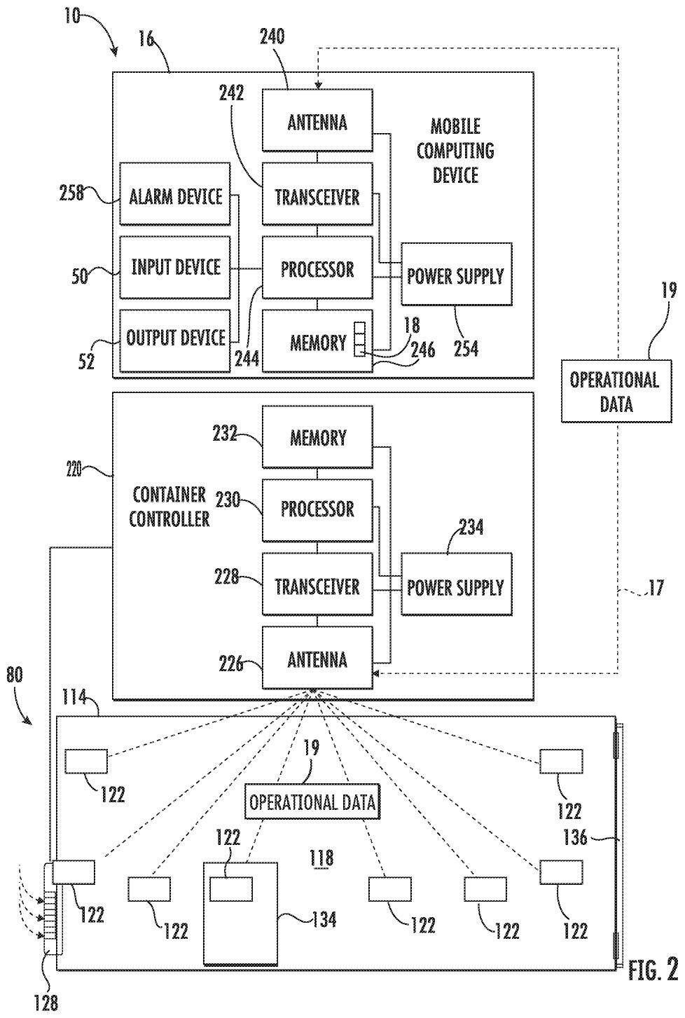

FIG. 2 illustrates a block diagram of the analytics system of FIG. 1, in accordance with an embodiment of the disclosure; and

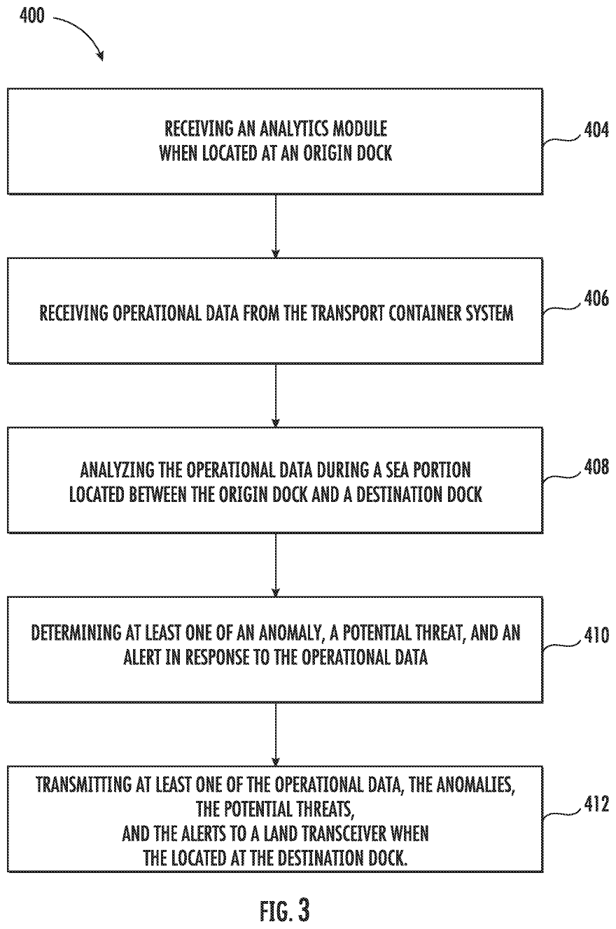

FIG. 3 is a flow diagram illustrating a method of monitoring operation of a transport container system on a transport ship, according to an embodiment of the present disclosure.

### DETAILED DESCRIPTION

A detailed description of one or more embodiments of the disclosed apparatus and method are presented herein by way of exemplification and not limitation with reference to the Figures.

Conventional transport containers systems are typically not equipped to communicate directly to the internet while at sea, which makes performing data analytics on the operation (i.e., performance) of the transport containers systems in real-time often difficult. Embodiments disclosed herein seek to address performance of data analytics on transport containers systems while at sea.

Referring now to FIG. 1, an analytics system 10 for transport container systems 80 is illustrated, in accordance with an embodiment of the present disclosure. The analytics system 10 includes a mobile computing device 16 in wireless electronic communication with one or more transport container systems 80 through local wireless communication 17, such as, for example, Wi-Fi, Cellular, Bluetooth, LoRa, Sigfox, or similar local wireless communication known to one of skill in the art. The analytics system 10 utilizes an analytics module 18 to analyze operation (i.e., performance) of the transport container systems 80. The data analytics module 18 may be a computer program product (i.e., software) and/or a computer program product embodied on a tangible storage medium (e.g., software on an SD card).

A transport ship 60 is illustrated in FIG. 1 in accordance with an embodiment of the present disclosure. The transport ship 60 can be configured for any type of transportation mode but for purposes of clarity and brevity will be referred to hereinafter as a transport ship 60. The transport ship 60 includes a hull 62, a propeller (not shown) to drive the hull 62 through water, an engine room (not shown) that is disposed within the hull 62 to drive rotations of the propeller and a bridge or command center 64. The command center 64 is disposed within or on the hull 62 and includes a bridge and operational computers that control various operations of the transport ship 60. The hull 62 is operable to carry a plurality of transport container systems 80 within or on the hull 62. Each of the transport container systems 80 includes a transport refrigeration unit 128 (see FIG. 2) configured to provide conditioned air to an interior compartment 118 (see FIG. 2) within the transport container system 80, as discussed further below.

The transport ship 60 is configured to transport the transport container system 80 from an origination dock 12 across a sea portion 14 to a destination dock 13. As discussed above, during the sea portion 14, the transport container systems 80 may not be equipped to connect to a computing network 15 (e.g., the internet), thus analytics of the transport container systems 80 will be performed locally by an analytics module 18 stored on the mobile computing device 16. The mobile computing device 16 is configured to receive the analytics module 18 when the transport ship 60 is located at the origination dock. Along with the analytics module 18 the mobile computing device 16 also receives information about a fleet (i.e., one or more) transport container system 80 and connectivity information when the transport ship 60 is located at the origination dock 12 (e.g., Wi-Fi, Bluetooth, or other wireless connection credentials to be able to connect to the transport container system 80 when there is no connection to a computing network 15). The mobile computing device 16 is configured to receive the analytics module 18 from the computing network 15 through a land transceiver 20, 22. A fleet diagnostics platform 15a may be located on the computing network 15. The fleet diagnostics platform 15a may be used for big data analytics of a fleet (i.e., one or more) transport container systems 18 on one or more transport ships 60. The fleet diagnostics platform 15a is a source platform that stores and pushes container mapping, connection configuration, analytics module 18 to the computing device 16 in FIG. 1. When the transport ship 60 reaches a destination dock 13 or concludes the journey the operational data 19, anomalies 32, potential threats 34, and alerts 36 will be uploaded to the computing network 15 and compared amongst one or more transport ships for further analysis.

While docked at the origination dock 12, the analytics module 18 may be wirelessly transferred from a land transceiver 20 located at the origination dock 12 via local wireless communication 17. The transceiver 20 in communication with the computing network 15. In other embodiment, the analytics module 18 may be installed into the mobile computing device 16 using a tangible storage medium. The mobile computing device 16 may be a wireless capable portable computing device, such as, for example, a smartphone, a smart watch, a tablet computer, a laptop computer, or similar device known to one of skill in the art.

The mobile computing device 16 is in wireless electronic communication with the transport container system 80 during the sea portion 14 through local wireless communication 17. Operational data 19 is transmitted from the transport container system 80 to mobile computing device 16 and the mobile computing device 16 is configured to analyze the operational data 19 using the analytics module 18. The mobile computing device 16 is configured to connect using a stored connection credential to a fleet of (i.e., one or more) transport container systems 80 in a sequence and download the operation data 19 from each of the transport container system 80. The collection of operational data 80 collection and/or the polling period of each of the one or more transport container systems 80 is configurable and based on the configuration the mobile computing device 16 will connect to the transport container system 80 for the operation data 19. In one embodiment, the analytics module 18 may analyze the operational data 19 to determine anomalies 32 in the operational data 19 and potential threats 34. The analytics module 18 may further determine alerts 36 in response to the anomalies 32 and potential threats 34. The operational data 19, anomalies 32, potential threats 34, and alerts 36 may be transmitted from the mobile computing device 16 to a ship computing device 66 of the transport ship 60. The alert 36 may activate an alarm 11 on the mobile computing device 16 and/or the ship computing device 66 to capture the attention of an individual. The alarm 11 may be audible, visually, and/or vibratory. In addition to the detection of anomalies 32, potential threats 34, and alerts 36, the mobile computing device 16 and/or analytics module 18 might also include possible troubleshooting mechanisms to help a local technician look/resolve the problem. The analytics module 18 could also have program modules to respond back or send commands to the transport container systems 80 to handle known system error/threat conditions.

The ship computing device 66 may then transmit the operational data 19, anomalies 32, potential threats 34, and alerts 36 to the computing network 15 (e.g., internet, remote server) through cellular or satellite communications. Although the computer network 15 is depicted herein as a single device, it should be appreciated that the computer network may alternatively be embodied as a multiplicity of systems. Due to an increased cost associated with cellular and satellite transmission directly to the computing network 15, the analytics system 10 may refrain from transmission of the operational data 19, anomalies 32, potential threats 34, and alerts 36 to a computing network 15 (e.g., internet, remote server) through cellular or satellite communications. When the transport ship 60 arrives at the destination dock 13, the mobile computing device 16 may be configured to transfer at least one of the operational data 19, the anomalies 32, the potential threats 34, and the alerts 36 to a land transceiver 22 located at the destination dock 13 via local wireless communication 17. Advantageously, by transferring the operational data 19, the anomalies 32, the potential threats 34, and the alerts 36 through local wireless communication 17, as opposed to cellular or satellite communications, the transmission of the operational data 19, the transmit anomalies 32, potential threats 34, and alert 36 may then be transmitted to the computer network 15 at a lower cost.

Referring now to FIG. 2, with continued reference to FIG. 1, a block diagram of the analytics system 10 is illustrated, in accordance with an embodiment of the present disclosure. The transport container systems 80 are used to transport perishable goods and environmentally sensitive goods (herein referred to as perishable goods 34). In the illustrated embodiment, the transport container includes an environmentally controlled container 114, a transport refrigeration unit 128, and perishable goods 134. The container 114 may define an interior compartment 118.

In the illustrated embodiment, the transport refrigeration unit 128 is operably associated with the container 114 to provide desired environmental parameters, such as, for example temperature, pressure, humidity, carbon dioxide, ethylene, ozone, light exposure, vibration exposure, and other conditions to the interior compartment 118. In further embodiments, the transport refrigeration unit 128 is a refrigeration system capable of providing a desired temperature and humidity range. The transportation refrigeration unit 128 may be powered by an energy source such as, for example, gasoline, diesel, electricity, or another known energy source to a person skilled in the art. The perishable goods 134 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport container system 80 includes sensors 122. The sensors 122 may be utilized to monitor operational data 19 internal and external to the container 114. The operational data 19 may include information regarding the perishable goods 134 being transported by the transport container system 80, data of the transport refrigeration unit 128, and/or data of the overall transport container system 80, as described further below. The operational data 19 monitored by the sensors 122 may include but are not limited to temperature, pressure, humidity, carbon dioxide, ethylene, ozone, light exposure, vibrations, and other conditions in the interior compartment 118. Accordingly, suitable sensors 122 are utilized to monitor the desired parameters. Advantageously, sensors 122 may be selected for certain applications depending on the perishable cargo to be monitored and the corresponding environmental sensitivities. In an embodiment, temperatures are monitored. As shown in FIG. 2, the sensors 122 may be placed directly on the perishable goods 34.

Further, as in the illustrated embodiment, sensors 122 may be used to monitor various operational data 19 of the transport container system 80. These sensors 122 may be placed in a variety of locations including but not limited to on the transport refrigeration unit 128, on a door 136 of the container 114 and throughout the interior compartment 118. The sensors 122 may be placed directly within the transport refrigeration unit 128 to monitor the performance and power usage of the transport refrigeration unit 128. Individual components internal to the transport refrigeration unit 128 may also be monitored by sensors 122 to detect performance aspects, such as, for example usage cycles, duration, temperatures and pressure of individual components. As seen, the sensors 122 may also be placed on the door 136 of the container 114 to monitor the position of the door 136. Whether the door 136 is open or closed affects both the temperature of the container 114 and the performance of the transport refrigeration unit 128. For instance, in hot weather, an open door 136 will allow cooled air to escape from the container 114, causing the temperature of the interior compartment 118 to rise, which creates additional stress on the transport refrigeration unit 128 by forcing the transport refrigeration unit 128 to work harder to cool the interior compartment 118. Additionally, the sensors 122 may also detect local weather experience by the transport container system 80. The local weather affects the temperature of the container 114 and thus affects the operation of the transport refrigeration unit 128. For instance, the transport refrigeration unit 128 may have to work harder on a container 114 travelling through a hot environment that is exposed to long period of heat and solar gain.

As illustrated in FIG. 2, the transport container system 80 may further include, a container controller 130 configured to log operational data 19 from the sensors 122 at a selected sampling rate. The container controller 130 may be enclosed within the transport refrigeration unit 128 or separate from the transport refrigeration unit 128. The container controller 130 is illustrated separate from the transport refrigeration unit 128 for ease of illustration. The operational data 19 may further be augmented with time, position stamps or other relevant information.

The container controller 130 generally includes an antenna 226, a transceiver 228, a processor 230, a memory 232, and a power supply 234. The transceiver 228 is capable of transmitting and receiving operational data 19 from at least one of the sensors 122 and the mobile computing device 16. The transceiver 228 may, for instance, be a Wi-Fi, Cellular, Bluetooth, LoRa, Sigfox transceiver, or another appropriate wireless transceiver. The antenna 226 is any antenna appropriate to the transceiver 228. The processor 230 and memory 232 are, respectively, data processing, and storage devices. The memory 232 may be RAM, EEPROM, or other storage medium where the processor 230 can read and write data including but not limited to configuration options. The power supply 234 is a power source such as line power connection, a power scavenging system, and/or a battery system that powers the container controller 130.

The mobile computing device 16 generally includes an antenna 240, a transceiver 242, a processor 244, a memory 246, an input device 250, an output device 252, and a power supply 254. The transceiver 242 is a transceiver of a type corresponding to the transceiver 228, and the antenna 240 is a corresponding antenna. In some embodiments, the transceiver 242 and the antenna 240 may also be used to communicate with the transceiver 228 and antenna 226 of the container controller 130. The memory 246 may be RAM, EEPROM, or other storage medium where the processor 230 can read and write data including but not limited to configuration options. The mobile computing device 16 also includes analytics module 18. Embodiments disclosed herein, may operate through the analytics module 18. The analytics module 18 may be stored on the memory 246 of the mobile computing device 16. The mobile computing device 16 may also include an alarm device 258 configured to generate an audible, vibratory, and/or visual alarm 11 (e.g., see FIG. 1). For example, the alarm device 258 may be a vibratory mechanism configured to vibrate when the alarm 11 is activated. In another example, the alarm device 258 may be a speaker configured to emit an audible alert when the alarm 11 is activate. In another example, the alarm device 258 may be a display screen or light of the mobile computing device 16 configured to flash or strobe when the alarm 11 is activated.

Referring now to FIG. 3, with continued reference to FIGS. 1-2, a flow chart of a method 400 of monitoring operation of a transport container system 80 on a transport ship 60 is illustrated, in accordance with an embodiment of the disclosure. The method 400 may be performed by the mobile computing device 16. At block 404, an analytics module 18 is received when located at an origin dock 12. At block 406, operational data 19 is received from the transport container system 80. The operational data 19 is received from the transport container system 80 through local wireless communication 17. The local wireless communication 17 may include at least one of Wi-Fi, Cellular, Bluetooth, LoRa, and Sigfox.

At block 408, the operational data 19 is analyzed during a sea portion 14 located between the origin dock 12 and a destination dock 13. At block 410, at least one of an anomaly 32, a potential threat 34, and an alert 36 is determined in response to the operational data 19. At block 412, at least one of the operational data 19, the anomalies 32, the potential threats 34, and the alerts 36 is transmitted to a land transceiver 22 when the located at the destination dock 13. As discussed above, the land transceiver 22 is configured to transmit the at least one of the operational data 19, the anomalies 32, the potential threats 34, and the alerts 36 to a computing network 15.

Once the anomalies 32 and the potential threats 34 is detected/identified, the analytics module 18 may also have the capabilities to take action through an actionable response for known anomalies 32 and potential threats 34. The actionable responses could include sending a two-way command to the transport container system 80 to handle the anomalies 32 and/or the potential threats 34 or activate an alert 36 that may include directions to handle the anomalies 32 and/or the potential threats 34 to a locally present technician.

The method 400 may further comprise: activating an alarm 11 in response to the alert 36, as described above. The method 400 may additionally comprise: transmitting at least one of the operational data 19, the anomalies 32, the potential threats 34, and the alerts 36 to a ship computing device 66 of a transport ship 60 during the sea portion 14.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of monitoring operation of a transport container system on a transport ship, the method comprising:
receiving an analytics module when located at an origin dock;
receiving operational data from the transport container system;
analysing the operational data during a sea portion located between the origin dock and a destination dock;
determining at least one of an anomaly, a potential threat, and an alert in response to the operational data; and
transmitting at least one of the operational data, the anomalies, the potential threats, and the alerts to a land transceiver when the located at the destination dock.

2. The method of claim 1, further comprising:
activating an alarm in response to the alert.

3. The method of claim 1, wherein the operational data is received from the transport container system through local wireless communication.

4. The method of claim 3, wherein the local wireless communication includes at least one of Wi-Fi, Cellular, Bluetooth, LoRa, and Sigfox.

5. The method of claim 1, further comprising:
transmitting at least one of the operational data, the anomalies, the potential threats, and the alerts to a ship computing device of a transport ship during the sea portion.

6. The method of claim 1, wherein the land transceiver is configured to transmit the at least one of the operational data, the anomalies, the potential threats, and the alerts to a computing network.

7. An analytics system for monitoring operation of a transport container system on a transport ship, the analytics system comprising:
a sensor configured to monitor operational data of a transport container system;
a container controller configured to collect operational data from the sensor;
a mobile computing device in wireless electronic communication with the container controller through local wireless communication, the mobile computing device comprising:
a processor; and
a memory comprising computer-executable instructions that, when executed by the processor, cause the processor to perform operations, the operations comprising:
receiving an analytics module when located at an origin dock;
receiving operational data from the transport container system;
analysing the operational data during a sea portion located between the origin dock and a destination dock;
determining at least one of an anomaly, a potential threat, and an alert in response to the operational data; and
transmitting at least one of the operational data, the anomalies, the potential threats, and the alerts to a land transceiver when the located at the destination dock.

8. The analytics system of claim 7, wherein the operations further comprise:
activating an alarm in response to the alert.

9. The analytics system of claim 7, wherein the operational data is received from the transport container system through local wireless communication.

10. The analytics system of claim 9, wherein the local wireless communication includes at least one of Wi-Fi, Cellular, Bluetooth, LoRa, and Sigfox.

11. The analytics system of claim 7, wherein the operations further comprise:
transmitting at least one of the operational data, the anomalies, the potential threats, and the alerts to a ship computing device of a transport ship during the sea portion.

12. The analytics system of claim 7, wherein the land transceiver is configured to transmit the at least one of the operational data, the anomalies, the potential threats, and the alerts to a computing network.

13. A computer program product tangibly embodied on a computer readable medium, the computer program product including instructions that, when executed by a processor, cause the processor to perform operations comprising:
receiving an analytics module when located at an origin dock;
receiving operational data from the transport container system;
analysing the operational data during a sea portion located between the origin dock and a destination dock;
determining at least one of an anomaly, a potential threat, and an alert in response to the operational data; and
transmitting at least one of the operational data, the anomalies, the potential threats, and the alerts to a land transceiver when the located at the destination dock.

14. The computer program product of claim 13, wherein the operations further comprise:
activating an alarm in response to the alert.

15. The computer program product of claim 13, wherein the operational data is received from the transport container system through local wireless communication.

16. The computer program product of claim 15, wherein the local wireless communication includes at least one of Wi-Fi, Cellular, Bluetooth, LoRa, and Sigfox.

17. The computer program product of claim 13, wherein the operations further comprise:
transmitting at least one of the operational data, the anomalies, the potential threats, and the alerts to a ship computing device of a transport ship during the sea portion.

18. The computer program product of claim 13, wherein the land transceiver is configured to transmit the at least one of the operational data, the anomalies, the potential threats, and the alerts to a computing network.
